(19) United States
(12) Patent Application Publication
(10) Pub. No.: US 2008/0294607 A1
(43) Pub. Date: Nov. 27, 2008

(54) SYSTEM, APPARATUS, AND METHOD TO PROVIDE TARGETED CONTENT TO USERS OF SOCIAL NETWORKS

(76) Inventors: Ali Partovi, Piedmont, CA (US); Hadi Partovi, Seattle, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/124,983

(22) Filed: May 21, 2008

Related U.S. Application Data
(60) Provisional application No. 60/939,806, filed on May 23, 2007.

(51) Int. Cl. G06F 7/06; G06F 17/30

(52) U.S. Cl. 707/3; 707/E17.014

(57) ABSTRACT

A system, apparatus, and method for providing targeted content to users of a social network. The system, apparatus, and method may be used to provide advertisements, promotions, and other relevant content to a user of a social network based on analysis of the user's preferences, interests, and tastes as expressed in data contained in the user's social network. Additional targeted-content may be selected and provided to a user based on the preferences, interests, and tastes of a user's friends within the social network.

### CROSS-REFERENCES TO RELATED APPLICATIONS

The present application claims benefit to U.S. Provisional Patent Application No. 60/939,806, filed May 23, 2007 the complete disclosure of which is incorporated herein by reference.

### BACKGROUND

The present invention is directed to systems, apparatus and methods for delivering advertising content, and more specifically, to a system, apparatus and method for delivering targeted advertising, promotional and related content to users of social networks.

The targeting of content such as advertisements and promotional offers to users is a service of great interest and value to both the recipients and the suppliers of the content. For recipients it represents a way to discover products and services, sometimes in return for receiving a discount or other form of incentive. For suppliers of the products or services, it represents a way to increase revenue by attracting new users to the product or service. Advertising also serves to inform existing users and potential new users about new or improved products or services. Targeted content may also be used to strengthen the business relationship with, and customer satisfaction of existing users.

Social networks and related applications have rapidly increased in popularity. Such networks and applications can be used to build relationships, discover products and services, and exchange information and content, among other uses. Because of their popularity and the demographics of the network users, social networks provide a potentially valuable platform for presenting advertisements, promotions, and other forms of targeted content to users of the network. The presentation of targeted content represents one example of an attempt to monetize social networks, and provides a way to generate revenue and drive usage of other social network applications and features. Successfully generating revenue or otherwise monetizing social networks can also act to bind such networks to the economy outside the network, leading to increased opportunities for both revenue and the members of the network. Thus, because of the growing popularity and demographics of social networks, such networks provide an opportunity for advertisers, if an effective and properly implemented system for selecting and delivering advertisements and other promotional materials could be developed.

In some present systems that select content for delivery to a user, the content may be selected based on a relationship between the content and the user profile or situation, the user's preferences or past behavior, or another suitable filtering or selection criteria. An example would be content selection based on contextual criteria, such as a characteristic of a web page the user is viewing, the search terms used to access a web page, or another relationship between a characteristic of the content delivered and the user's past behavior, current behavior, or demographics. For example, at present, there are advertising engines that select and display advertising or promotional content that is contextually relevant to the web page where the advertising is displayed (a typical example would be the AdSense system from Google™). There are also believed to be “behaviorally” based advertising engines that display contextually relevant advertising to the user based on the user's browsing behavior. Examples of this type of advertising engine are believed to include Revenue Science, Tacoda, and Yahoo™'s behavioral advertising engine.

However, a disadvantage of the existing approaches to providing targeted advertising content is that the content provided to the user is selected based on an inference as to what the user is interested in, with the inference based on a search query or the characteristics of a web page viewed by a user. In this process, advertising engines that serve the content try to determine what topics or information a user may be interested in, primarily based on the web pages that they visit. For example, behaviorally-targeted advertising solutions may display advertisements for automobiles to users who have a history of browsing automobile sites. This inference may be correct in some cases, but it is also liable to be incorrect in many cases and result in presenting a user with a significant amount of undesired content that is not directed to their true interests or tastes. As a result, such content may be ignored or lead to counter-productive behaviors by the user (such as developing a negative impression of the supplier of the content).

Thus, one disadvantage with the conventional methods of providing targeted content is that such methods are based on an inference from the user's behavioral pattern, instead of being based on direct knowledge regarding a user's actual interests or tastes. Furthermore, the present methods do not take into account other information available within a social network that may provide clues as to a user's interests or tastes—in particular, the user's list of friends on the social network.

What is desired is a system and associated apparatus and method for providing targeted content such as advertisements to a user of a social network that overcomes the disadvantages of present approaches.

### SUMMARY

The present invention is directed to systems, apparatus, and methods for providing targeted content to users of a social network. The systems, apparatus, and methods may be used to provide advertisements, promotions, and other relevant content to a user of a social network based on analysis of the user's preferences, interests, and tastes as expressed in data contained in the user's social network. Targeted content may also be selected and provided to a user based on the preferences, interests, and tastes of a user's friends within the social network.

In contrast to methods of selecting content based on an inference as to the user's interests, content is selected based on actual information about a user's preferences, tastes, interests, etc. as expressed by the user within the social network. Using the social network data, the system, apparatus, and methods may select and provide content such as advertising, promotional materials, offers to provide products or services, and other incentives or content to a user. The selection of the content may be based directly on the user's social network data, or be selected based on determining content relevant to preferences, tastes, interests, etc. that are related to those of the user. The systems, apparatus, and methods may also provide content to a user based on information about the user's social network “friends” and their respective preferences, tastes, and interests that are contained within the network. In some cases, the provided content may be so effectively selected that it can provide a source of highly relevant and desirable information for users.

In accordance with one embodiment, a method of providing content targeted for a user of a third party social network is provided. The method includes collecting information about the user from the third party social network and processing the collected information to identify keywords that are relevant to determining targeted-content for the user. A relevant category for each identified keyword may be determined. The method further includes conducting a search using the each identified keyword over the determined databases for locating matching targeted-content and presenting the matching targeted-content to the user.

In accordance with another embodiment, a method of providing concert content targeted for a user of a social network is provided. The method includes collecting information about the user and/or about friends of the user from the social network and processing the collected information to identify keywords that are relevant to determining concert content targeted for the user (or friends). A search is conducted over databases, using the each identified keyword, in order to locate matching concert content. An output including the matching concert content is generated and presented to the user. The output may be presented in a calendar format that includes but not is limited to, one or more of ticket purchase information, time information, venue information, or artist information. For example, the method may provide a user with a concert-calendar of music concerts matching the user's music tastes and friends' music tastes (or for example, a movie calendar of the shows in theatres or DVD New Releases matching the user's tastes, etc.) via email, or the like.

In accordance with yet another embodiment, information about a user's or friend's tastes, preferences, hobbies, interests, favorite music, movies, events, etc. may be processed to enable providing advertisements, offers, promotions and the like to the user, the friend, or both. The advertisements, offers, promotions, etc. may be targeted to the user and/or friend based on personal information about the user or friend (birth date, location, marital status, or socio-economic data) and/or based on the user or friend's preferences, interests, tastes, hobbies, etc. as indicated by information on their social network pages. As noted, notice of an event or tickets to a concert could be advertised or offered based on a user or friend's interests or list of favorite artists. Further, based on a sufficient degree of similarity or compatibility between a user and friend, a common advertisement or other information could be presented to both as a way of encouraging activity within the social network.

### BRIEF DESCRIPTION OF THE DRAWINGS

FIG. 1 is a pictorial diagram showing an exemplary computing environment in which embodiments may be implemented;

FIG. 2 is a flowchart illustrating a method for providing targeted-content to users of a social network, in accordance with some embodiments of the present invention;

FIG. 3 is a flowchart illustrating a method for processing collected information for a search and matching process, in accordance with some embodiments of the present invention; and

FIG. 4 is a flowchart illustrating another method for providing targeted-content to users of a social network, in accordance with some embodiments of the present invention;

FIG. 5 is a flowchart illustrating a method for locating directly or indirectly matching targeted-content or offers from databases, in accordance with some embodiments of the present invention; and

FIGS. 6A-6C are exemplary screen displays where a resulting list of targeted content is presented to a user, in accordance with some embodiments of the present invention.

### DETAILED DESCRIPTION

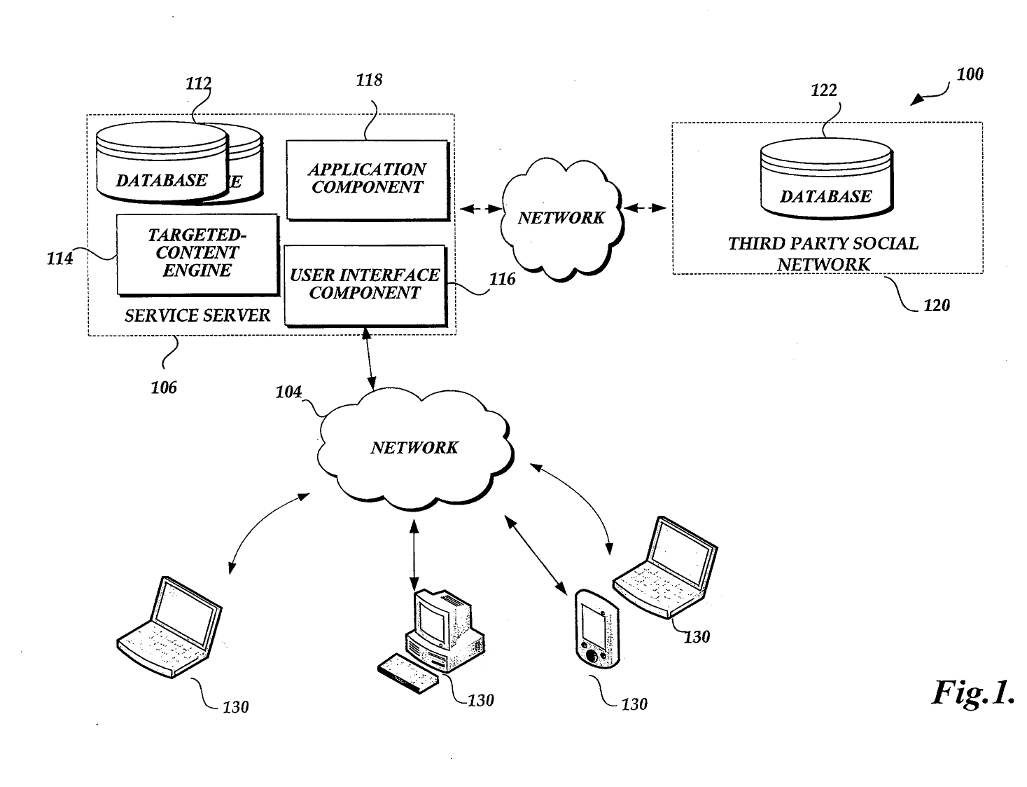

FIG. 1 illustrates an example of an environment 100 for implementing aspects in accordance with various embodiments. As will be appreciated, different environments may be used, as appropriate, to implement various embodiments. The environment 100 shown includes an electronic user device 130, which can include any appropriate device operable to send and receive requests, messages, or information over an appropriate network 104 and convey information back to a user of the device. Examples of such client devices include personal computers, cell phones, handheld messaging devices, laptop computers, personal data assistants, and the like. The network can include any appropriate network, including an intranet, the Internet, a cellular network, a local area network, or any other such network or combination thereof. Protocols and components for communicating via such a network are well known and will not be discussed herein in detail. Communication over the network can be enabled by wired or wireless connections, and combinations thereof.

The environment in one embodiment is a distributed computing environment utilizing several computer systems and components that are interconnected via communication links, using one or more computer networks or direct connections. However, it will be appreciated by those of ordinary skill in the art such a system could operate equally well in a system having fewer or a greater number of components than are illustrated in FIG. 1. Thus, the depiction of the system 106 in FIG. 1 should be taken as being illustrative in nature, and not limiting to the scope of the disclosure.

The illustrative environment further includes at least one application server 106 including an application component 118, a targeted-content engine 114, a user interface component 116, and one or more databases 112. The application server 106 typically will include an operating system that provides executable program instructions for the general administration and operation of that server, and typically will include a computer-readable medium storing instructions that, when executed by a processor of the server, allow the server to perform its intended functions. Suitable implementations for the operating system and general functionality of the servers are known or commercially available, and are readily implemented by persons having ordinary skill in the art, particularly in light of the disclosure herein.

In one embodiment, the application server 106 is a web-based network service server. The web-based network service server (hereinafter, service server) provides various services related to the social network including a targeted-content (offers) service for the users. Example of services that can be provided by the service server include, but are not limited to, recommending a product or a service, campaigning a targeted advertisement, providing a concert calendar tailored to a user, purchasing targeted concert tickets, etc. Once registered with the service server, each user can receive targeted-content or offers. A term, “targeted-content” or “targeted-offers”, as used herein, refers to offers, advertisements, promotional materials, product or service information, coupons or other incentives, etc. specifically targeted to the user's tastes/interests (and optionally to the friends' tastes/interests). In some embodiments, the service server 106 may be implemented so as to provide the targeted content in one or more of multiple formats, including, but not limited, (a) a web-page that shows a list of targeted-offers to a user; (b) a service that sends a regular email newsletter containing the targeted-offers; or (c) an ad-serving engine that inserts one or more targeted-offers into another web-page or application.

The service server 106 or targeted-content engine 114 obtains social network information from the user or from the data base. The service server 106 accesses data regarding a user's preferences, personal “tastes/interests”, hobbies, etc. from the user's social network. If desired, the service server 106 accesses the user's list of friends from the social network, and from that list data regarding each friend's preferences, personal “tastes/interests”, hobbies, etc. In some embodiments, the system and method may obtain login or other authentication data regarding a user to enable the service server 106 to retrieve information from the third party social network in order to calculate compatibility. For example, the service server 106 can directly access the user's “friend” list and associated data from another social network 120 using the login credential of the user. A term “friend,” as used herein, refers to another user who is a member of a social network 120 and is identified or designated as a friend implicitly or explicitly by the user. Within a social network, a user generally maintains a “list of friends” for sharing information or communicating with each other. One example may be a buddy list selected by the user in a particular social network. The term “list of friends”, as used herein, refers to a group of friends whom the user indicates or specifies as a friend within the social network. After accessing the list of friends in the social network, information regarding each friend's preferences, interests, hobbies, tastes, etc. may be obtained from the social network. Subsequently, the targeted-content, including, but not limited to, promotions, offers, advertisements and other content specifically targeted to the user's tastes/interests (and optionally to the friends' tastes/interests) is determined and presented to the user.

The database 112 can include several separate data tables, databases, or other data storage mechanisms and media for storing data relating to a particular aspect. In one embodiment, the database 112 may include category-specific databases of tastes and interests, user profile databases, related-keyword databases (containing predetermined keywords that are related each other), targeted-content databases (containing content/offers and descriptions), or the like. In some embodiments, the category-specific databases of “interests” (tastes) may contain indexed specific interests within each “interest-category”. The “interest-category”, as used herein, refers to a predefined category for “interest” or a class of “interest.” For example, an interest-category may include “Music,” “Movies,” “Food,” “Sports,” “Activities”, “TV shows”, or the like. In some embodiments, a unique-identifier or other form of index may be resulted when the lookup on the databases is successful (e.g. “John Mayer” is matched to artist-ID 20360128). Such index or identifier may then be used in the targeted-content database and can be used to efficiently look up targeted-content or offers appropriate to the matching interest. It is noted that the database of categories or classes of “interests” may have been acquired from third party service providers, or have been constructed within the service server 106 based on previous provided services, etc. In one embodiment, the category-specific databases are 1) collected from third parties or 2) constructed via user-input of meta data (tag information) or other characterizing data for content items. In either scenario, such databases will typically have data that matches an interest-category (“Music,” “Movies,” “Food,” “Sports,” “Activities”, “TV shows”, etc.) to other. The database 112 is operable, through logic associated therewith, to receive instructions from the service server 106, and obtain, update, or otherwise process data in response thereto. In some embodiments, the database 112 or the targeted-content database is constructed and maintained by a third party service provider. For example, the targeted-content database may be managed by a third-party advertising partner that provides the service server 106 with a network interface to look up promotional or targeted-offers.

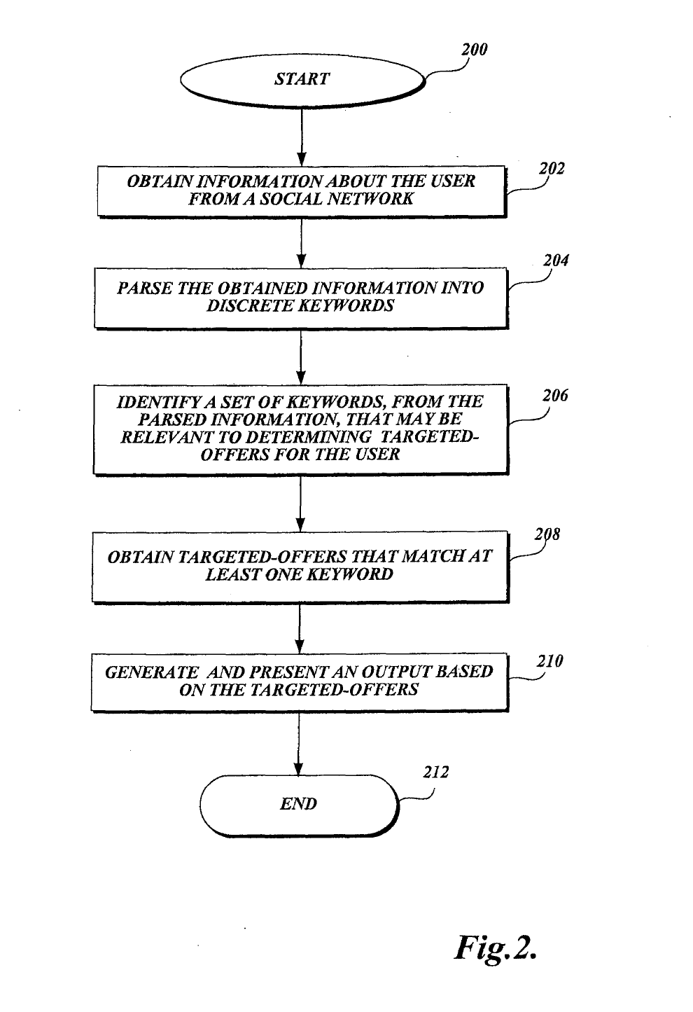

Referring to FIG. 2, a flowchart 200 illustrates a routine for determining targeted-content (hereinafter, targeted-offers) based on user's tastes, preferences, etc., in accordance with some embodiments of the present invention. It is understood that the description is exemplary and that other methods, processes, etc. may be utilized and fall within the concept of the invention.

Beginning with block 202, the service server 106 may access and collect information about a user, for example, data that characterizes a user's interests, tastes, hobbies, preferences, favorites, etc. (e.g., music, movies, activities, etc.). In one embodiment, the service server 106 may obtain the information about the user or additional information directly from the user or from a user profile database stored with the service server 106. In some embodiments, the service server 106 accesses a third party social network where the user is a member to obtain such information from the third party social network. In one embodiment, the obtained data may be in the form of text strings retrieved from relevant fields within the user's profile page on the third party social network (or from another Web page or data store accessible from the user's profile page). There are various ways to obtain information from a third party social network. For example, the data may be obtained via an API-interface provided by the social network site (for example an “FQL” query on the Facebook social network), or by utilizing a “screen-scraping” technique. In some embodiments, the service server 106 may collect login credentials or other authorization or access control data from the user (if the user's profile is protected from third-party access) and then use that information to access the third party social network for retrieving the information about the user.

Below is an example of a query using the Facebook FQL query language that may be used to retrieve a user's music tastes:

SELECT music FROM user WHERE uid=25695

Below is an example of the information that may be returned from such a query:

<?xml version=“1.0” encoding=“UTF-8”?>
<fql_query_response xmlns=“http://api.facebook.com/1.0/”
xmlns:xsi=“http://www.w3.org/2001/XMLSchema-instance” list=“true”>
<user>
<music>Phil Vassar, Johnny Cash, Alan Jackson, Tim McGraw</music>
</user>
</fql_query_response>

To collect similar information from a third party social network that does not provide a direct API, a “screen scraping” technique may be used. Generally described, “screen scraping” is a technique in which a computer program extracts data from the display output of another program. The screen scraping also includes computerized parsing of the HTML text in Web Pages. Through the screen scraping, the service server 106 can recognize and discard unwanted data, images, and display formatting. As mentioned above, the screen scraping is most often done to interface to a third-party system which does not provide a more convenient API interface.

As will be described in further detail, in most social networks a user's home or profile page (which is typically publicly viewable by anyone, or viewable after authentication as a network “friend”) includes sections for display of interests, favorites, hobbies, etc. (which may be separately identified for categories such as Music, Movies, etc.). In most cases, these interests/tastes are organized in fields that can be easily identifiable on HTML pages (which may be identified by “tags”), or accessible via queries. The information obtained from Web pages is typically suited to being parsed as a text string.

At block 204, the obtained information in the form of text string may be parsed into a set of discrete items (keywords). Briefly stated, formatting elements (e.g., HTML tags identified by < and > characters) may be first removed from the obtained information. The resulted string may be separated into discrete items by looking for common word-separators, such as a comma, semicolon, colon, dash, plus-symbol, ampersand, or the word “and”, for example. Further, because the information about the user on Web page(s) is typically a manually edited text by the user, the information may include extraneous information that may be not helpful or required for the matching/searching process. Thus, extraneous information is identified and removed as much as possible. For example, capitalized letters may be canonicalized to lowercase, leading and trailing white space may be removed, conjunctions such as “and” or “with” may be removed, etc., to reduce the user information to a minimal set of data that can more effectively be matched to targeted content descriptions in the targeted-content databases.

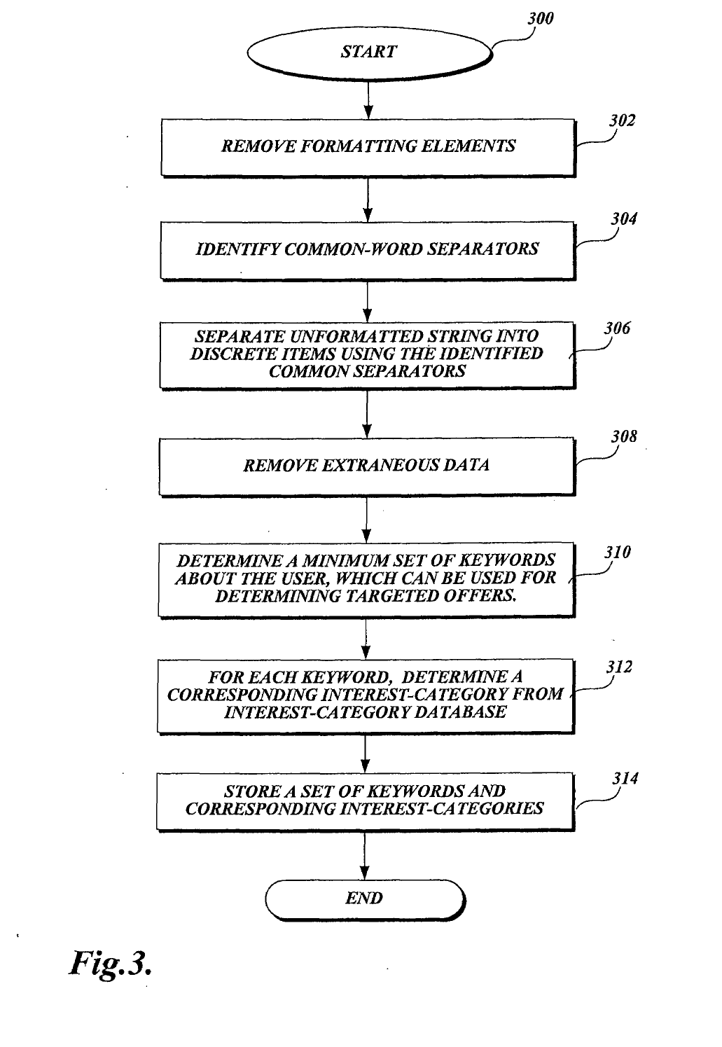

At block 206, the service server 106 may identify, from the parsed information, one or more keywords that can be relevant to determining matching targeted content for the user. For example, “etc,” “Others,” and the like may not be meaningful or relevant to determining matching targeted-offers. In addition, the service server 106 may identify a set of corresponding interest-categories that that are relevant to determining matching targeted contents from the parsed information. The interest-categories includes, but are not limited to, “Music,” “Movies,” “Food,” “Sports,” “Activities”, “TV shows”, etc. For example, if a user indicates that she likes a particular actress, the “Movies” category may be determined for a keyword parsed from user preference information about the actress. Blocks 204 and 206 will be discussed in a further detail below in connection with FIG. 3 that depicts a parsing process routine in accordance with an embodiment.

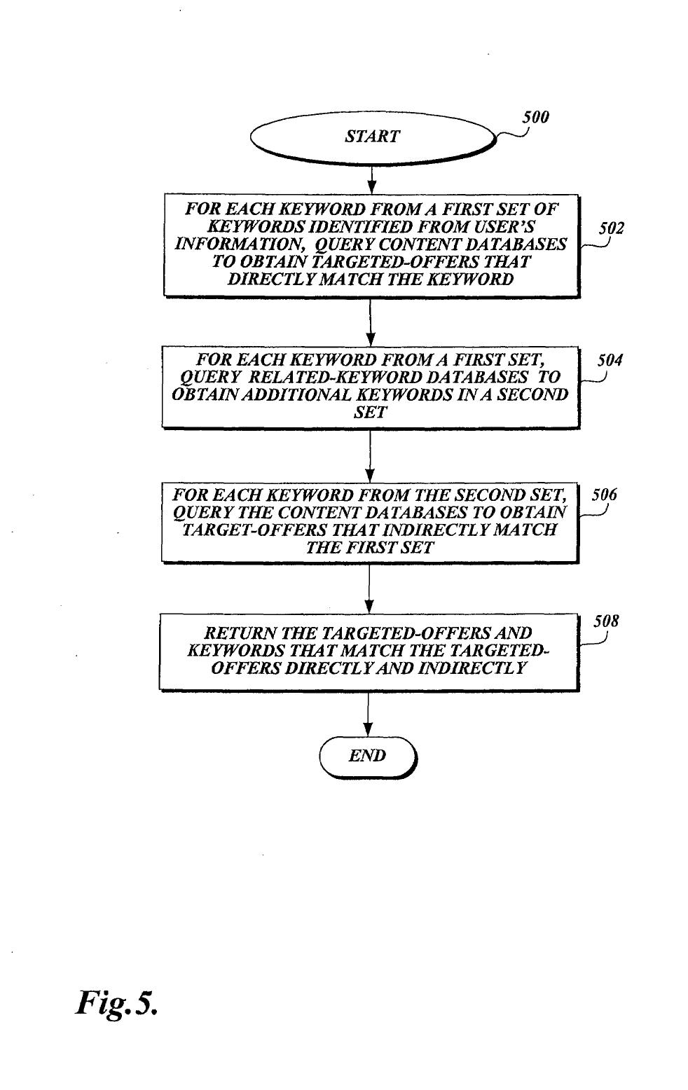

At block 208, the service server 106 obtains targeted-offers that directly or indirectly match one or more keywords. In one embodiment, the service server 106 queries the targeted-content databases with each identified keyword. The targeted-content databases to be queried may be determined by an interest-category relevant to the identified keyword. The service server 106 may also identify or obtain additional interest-categories or keywords that are somewhat related to the keywords extracted from the parsed user information. Such additional keywords and categories may be used to search more targeted-offers for the user. As will be appreciated, there are various ways to determine content/offers that match one or more keywords or categories. Some exemplary matching processes that can be used in some embodiments will be discussed in greater detail below in conjunction with FIG. 5. In some embodiments, the service server 106 stores a resulting list of targeted-offers in the user profile database. For each targeted-offer, an interest-category and a keyword that are used for the matching process may also be stored.

At block 210, the service server 106 generates and presents an output including a list of targeted-offers for the user. The output can include additional information, such as information about the targeted-offers, a keyword or interest-category relevant to the targeted-offers, or the like. As will be well appreciated, generating and presenting the output may be accomplished in multiple ways. In one embodiment, the service server 106 presents an output that displays all the obtained targeted-offers in groups. That is, the obtained targeted-offers or content may be grouped to assist the user to easily identify the targeted-content of interest. In one example, the targeted offers can be grouped based on a matching keyword, an interest-category or a search query. For example, the targeted offers may be grouped into “Offers matching your music tastes”, “Offers matching your favorite artist”, “Offers matching artists related to your favorite artist”, “Offers matching your friends' music tastes”, “Offers matching your favorite movies”, etc.

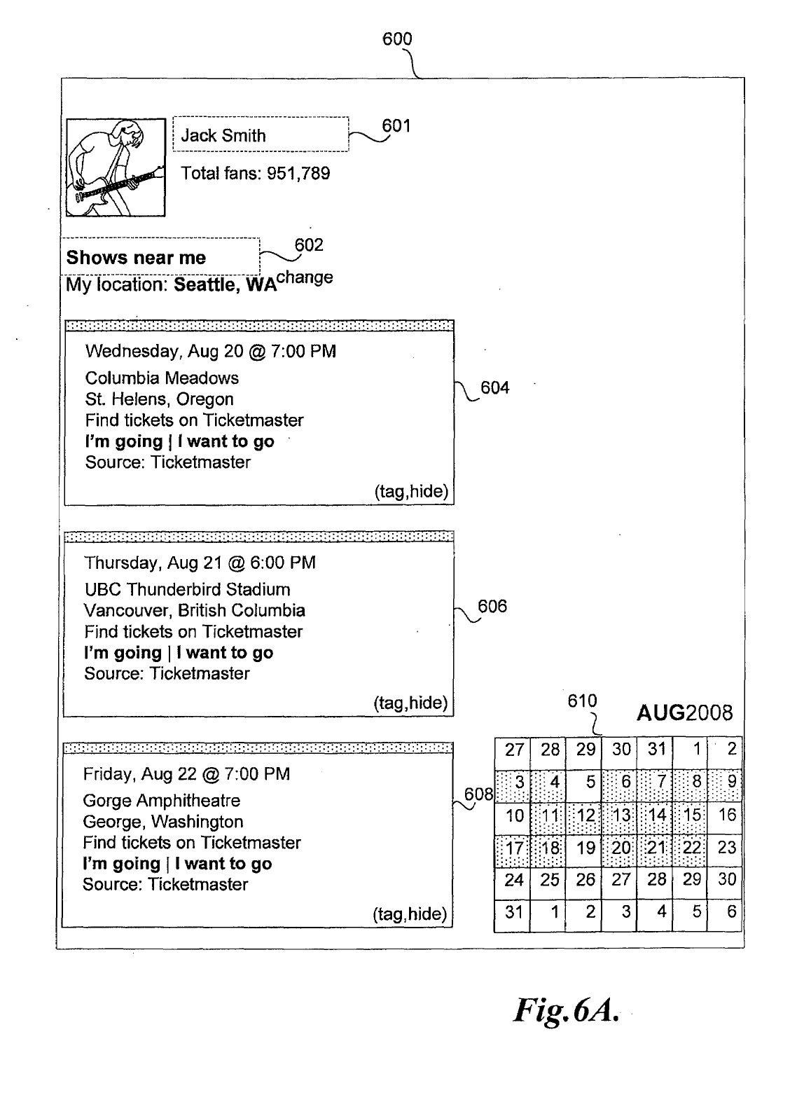

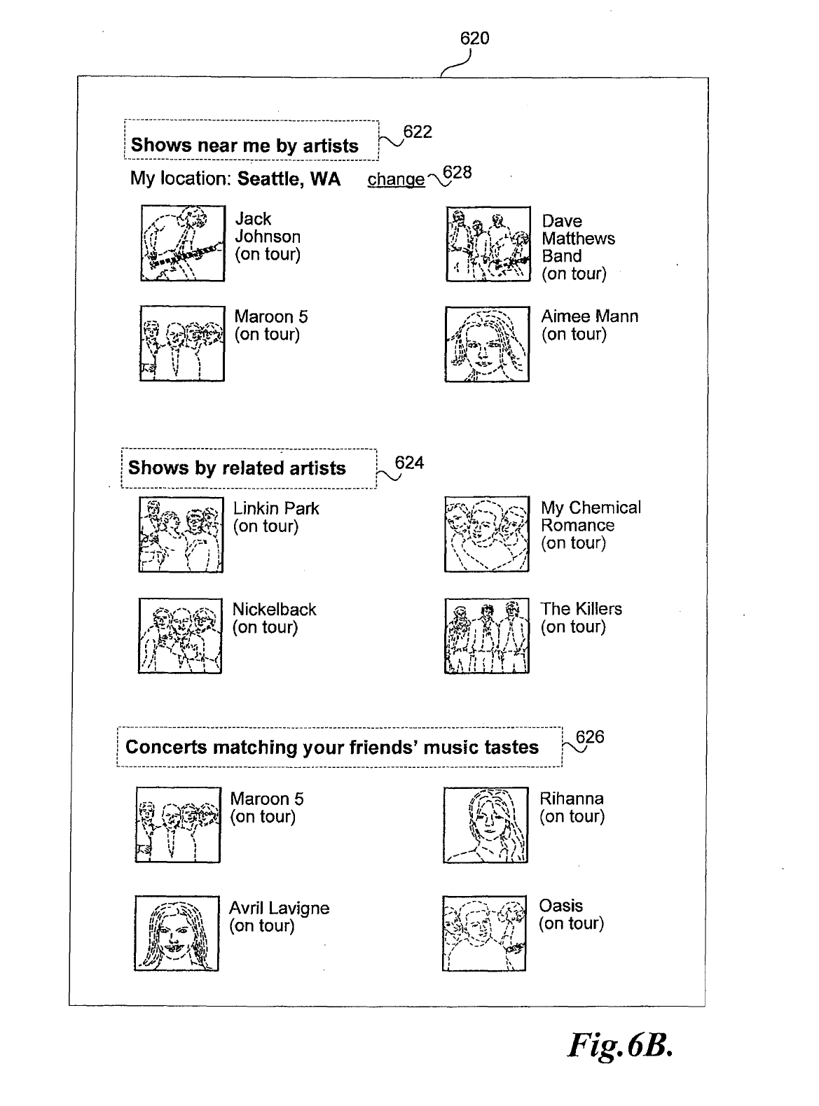

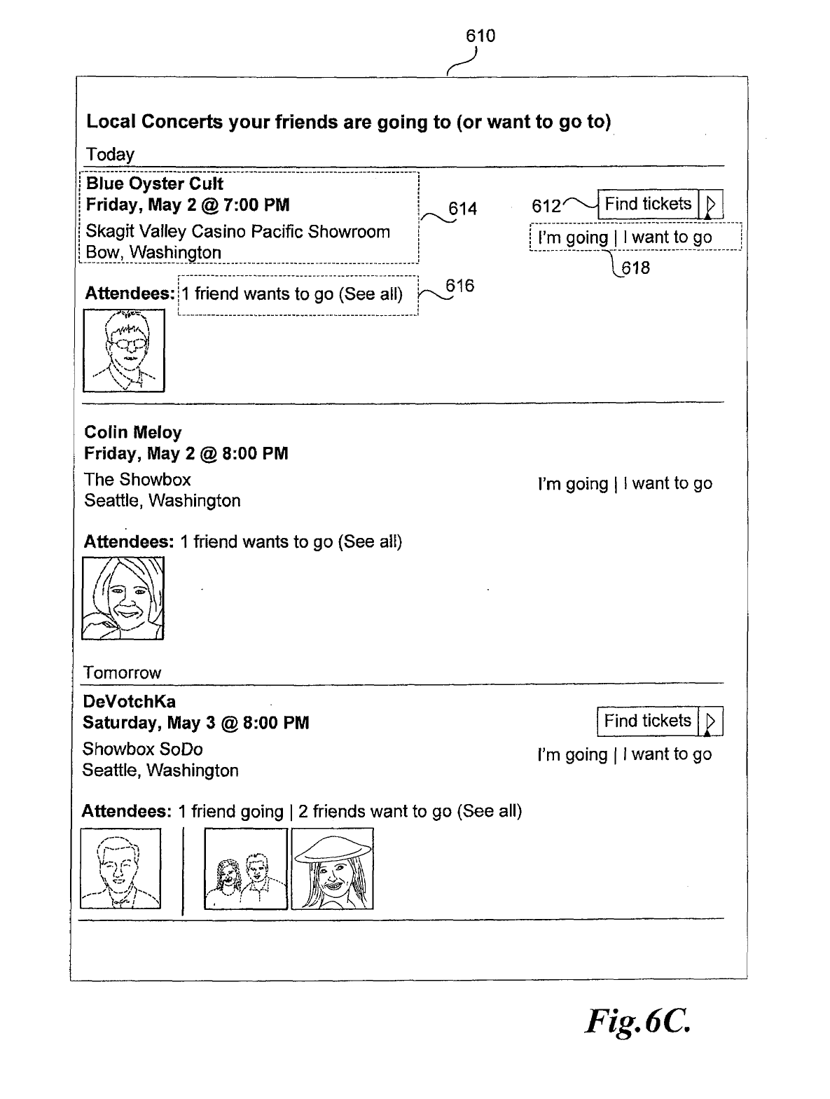

Referring now to FIG. 6B, the resulting lists of targeted offers about concerts are grouped into several groups, for example, “Shows near me by artist” 622, “Shows by related artists” 624, and “Concerts matching friends' music tastes” 626. As shown, a user can input new search criteria, such as “location” by choosing “change” selection 628 presented next to the location information. In one embodiment, in the context of a particular user visiting a web page or application, the service server 106 or the targeted-content engine 114 looks up the targeted offers/content for that user from the database (or a data store and cache), and randomly selects any one (or more) of the offers/content to display as an advertisement served in the context of a web page or application. In another embodiment, the service server 106 may provide the user with the resulting list of targeted-offers via email or text message. The targeted offers or content may be sorted, filtered, processed in a suitable form, or grouped as discussed above.

In some embodiments, a list of the friends of the user and information about each friend as specified within a social network may be accessed and collected from the social network. The information about each friend may include information about the friend's tastes, interests, preferences, hobbies, music, movies, or book choices, etc. (in general, whatever information the friend has provided to the social network regarding their preferences or interests). The service server 106 may then perform similar steps depicted in FIG. 2 for some or all of the “friends” on the list. As described with reference to accessing data regarding a user's interests, etc. in FIG. 2, information about each friend may be collected via an API-interface provided by the social network site (for example, an “FQL” query on the Facebook social network), or by using a “screen-scraping” technique. In some instances, that obtaining information regarding a user's “friends” and their interests may require collecting login credentials from the user (if the user's friend-list or the friends' profiles are protected from third-party access) and using that information to access the desired data.

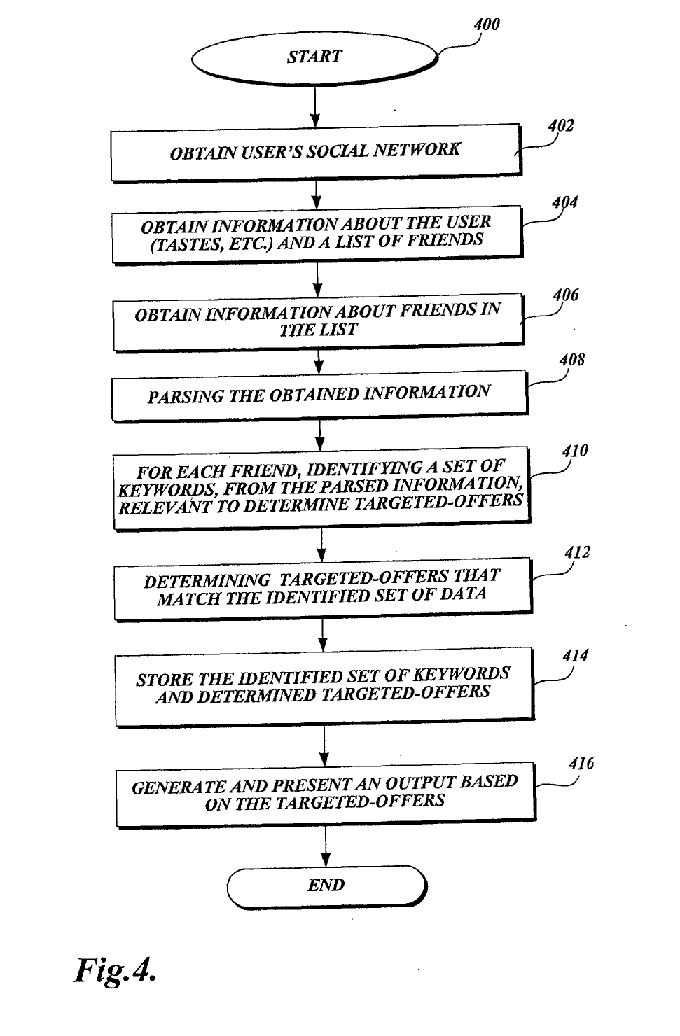

Referring now to FIG. 4, a flowchart 400 illustrates a routine for determining targeted-offers (content) based on user's and user's friends' tastes, preferences, etc., in accordance with some embodiments of the present invention. Beginning with block 402, the targeted-content engine 114 or the service server 106 obtains information about the user's social network where the user and friends are members. In some embodiments, when the user registers with the service server 106, the user may be asked to provide social networks where the user is a member. In one embodiment, the service server 106 may store such information (associated social networks, etc.) in the user profile information. The user can designate a particular social network for targeted-content services.

At block 404, the social network is accessed to obtain a list of friends specified or indicated by the user on the social network site. In some embodiments, the service server 106 obtains information relevant to determining friends of the user from the social network when the list of friends is not readily available. It is noted that the service server 106 typically does not have a way of access the user's information (related to the list of friends) stored with the third party social networks. Thus, the service server 106 may ask the user to provide the information that can be used to access the list of friends in the social network sites. For example, the list of friends can be obtained directly via a form asking the user for their username and password on the social network. As will be well appreciated, the list of friends may be a list, a file, or other forms of data containing an identification of those designated by a user as friends.

As will be discussed in further detail below, there are several ways to collect, obtain, or process information, about a list of friends or each friend, relevant to determining the targeted-content or offers. In some embodiments, the service server 106 may obtain the list of friends from a screen display of the user's home page (Web page) on a social network site. In such embodiments, the service server 106 may collect login credentials for the user to enable access to the user's personal information on the social network. Using the collected login credentials, the service server 106 may access the Web page(s) of the user where the user generally lists or identify his/her friends. In general, the user may list or identify names of friends, login identifiers of friends, etc. in a certain section on Web pages. Alternatively, the service server 106 may direct the user to login to the social network site so that the service server 106 can access the user's Web page(s) on the social network site. Once the Web page(s) is accessed, the service server 106 collects information about the friends of the user, such as a list of friends, a buddy list, etc. After obtaining the list of friends, the service server 106 “scrapes” public information about each friend, such as Web pages of the friend, on the social network site.

As will be well appreciated, there are other ways to access information about the user's friends in the social network in question. In one embodiment, the service server 106 may be provided with an appropriate interface to the social network site. For example, some social network sites provide an API interface, or the like so that other services can access directly the social network sites through the provided API interface.

At block 406, the targeted-content engine 114 accesses relevant data regarding each “friend” from the user's social network. In one embodiment, for each friend from the list of friends, the service server 106 accesses and collects data regarding the friend that are relevant to determining the targeted-offers for the user. Such data include, but are not limited to, the information about the friend's tastes, interests, preferences, hobbies, favorite music, movies, sports, book choices, etc. For example, the information that the friend has provided to the social network regarding their preferences or interests, or other indicators of their tastes or preferences may be used in the targeted-content determining method, heuristic, algorithm, etc.

As briefly discussed above, the API-interface provided by the social network site may be used to retrieve or collect data from Web pages of the social network site. The retrieved data may be obtained from the friend's home page (Web pages) or other locations on the social network, and may be generic or specific to their preferences. In some cases, the social network may provide a suitable interface, such as the FQL, (query language for Facebook) for querying information. In such cases, the data can be obtained directly using the suitable interface for querying, e.g., a query language.

In some embodiments, the data may be retrieved or collected through a “screen-scraping” technique or other suitable methods. When the service server 106 employs the screen-scraping technique, the service server 106 uses direct HTTP requests to the social network web-servers. That is, the service server 106 passes in the user's authentication credentials, and subsequently makes HTTP requests to retrieve the list of the user's friends. For each friend in the list, the service server 106 accesses a screen display of the friend's Web page(s). Subsequently, the service server 106 retrieves and parses data from the display of the friend's Web page(s) on the social network site.

As with FIG. 2, the obtained information may be parsed into a set of discrete items or keywords. For each friend's information, the service server 106 may identify, from the parsed information, a set of discrete items or keywords and corresponding interest-categories that may be relevant to determining matching targeted-offers as illustrated at block 410. The service server 106 obtains targeted-offers that directly and/or indirectly match a keyword from the set of identified taste/interest data and a relevant interest-category at block 412. The service server 106 stores the targeted-contents and matching items and categories in the user profile database at block 414. The service server 106 generates and presents an output including a resulting list of targeted offers and other information at block 416. The targeted-offers may be grouped or sorted in various ways. The output may be presented to the user in various formats. In some embodiments, the service server 106 may be implemented so as to provide the targeted content in one or more of multiple formats, including, but not limited, (a) a web-page that shows a list of targeted-offers to a user; (b) a service that sends a regular email newsletter containing the targeted-offers; or (c) an ad-serving engine that inserts one or more targeted-offers into another web-page or application.

Upon receipt of the output, the user may indicate, through user interactions, to accept, to show an interest in accepting, or act on the targeted offer. Such information may also be stored along with the targeted offer in the user profile database. For those targeted-offers that the user has an interest in accepting, the service server 106 may alert, inform, or otherwise notify the user (or their friends) about the targeted-offer periodically. In some embodiments, for each offer/content in the targeted-content database, users' interactions (indications) with respect to the offer or content may be stored. In one embodiment, a user may be provided with recommendations or notifications (via email, the network member's music inbox, or other means) for targeted-offers that were found for the friends of the user. Some users may want to see, when they make a decision on the targeted-offer, if any of their friends is interested in the targeted-offer. For example, if the targeted-offer is about Music and the user has purchased a concert ticket, some friends of the users may be provided with recommendations or notifications on the concert ticket. Referring now to FIG. 6C, an exemplary display window where a user can view concert content that were found for the friends of the user. As shown, the output includes the targeted-concert content, for example, “Blue Oyster Cult” 614, ticket purchase information, for example “Find Ticket” selection 612, user's selection, for example “I'm going/I want to go” 618, friend information 616.

Referring now to FIG. 3, a flowchart 300 depicts a parsing process routine of the obtained information about a user or a friend of the user in accordance with some embodiments of the present invention. As described above, the service server 106 may need to processes a text-based list (text string) of the user's information (interests, tastes, favorite activities, hobbies, music, movies, books, sports, etc.) into individually recognizable phrases, strings, or keywords. In one embodiment, a long string of text may be separated into comma separated values or sub-strings. As noted, in most social networks, a user's home or profile page (Web pages) includes sections for display of interests, favorites, hobbies, etc. (which may be separately identified for Music, Movies, etc.). In most cases, these interests/tastes are organized in well identified fields on HTML pages (which may be identified by “tags”), or accessible via queries. Such data is collected and parsed as text strings.

Beginning with block 302, the service server 106 removes formatting elements (e.g., HTML tags identified by < and > characters) from the text string. At block 304, the service server 106 identifies common word-separators, such as a comma, semicolon, colon, dash, plus-symbol, ampersand, or the word “and”, etc. At block 306, the service server 106 separates unformatted strings into discrete items or keywords using the identified common separators. At block 308, the service server 106 may remove extraneous data that may not be relevant to determining targeted-offers. For example, capitalized letters may be canonicalized to lowercase, leading and trailing white space may be removed, conjunctions such as “and” or “with” may be removed, etc. At block 310, the service server 106 determines a minimal set of keywords that can be used for a matching process. For example, when a user's favorite activities may be represented as “Kayaking, Skiing, and, Jogging, etc.” on the Web page, it would be parsed to a list of the following discrete items or keywords, such as, “Kayaking”, “Skiing”, “Jogging”, “etc”.

In some embodiments, the service server 106 may determine potentially relevant content or offers based on a matching of the keywords (obtained from the social network) to a related-keywords databases, category-specific databases, or databases containing other suitable descriptions of potential interests. At block 312, the server may determine an interest-category for each keyword. For example, the service server 106 may determine whether a keyword is related to an activity (e.g., “Kayaking”), music (e.g., “Madonna”), or a movie (e.g., “Star Wars”). In some embodiments, for each keyword, the system may filter the keyword by performing a text-based search (or matching process) over an interest-category database or other information identifying categories or classes of content. For example, if a user's Music tastes are listed as “John Mayer, Dave Matthews, and other similar artists”, the first two strings would be expected to match to artist names “John Mayer” and “Dave Matthews” in the “Music” category database, but “and other similar artists” is extraneous data that would produce no match and typically be filtered out.

In addition, in some embodiments, this step could involve using a spell-correction system or other heuristics or algorithms to determine potential matches based on similarly spelled words. As will be appreciated, there are several ways to accomplish this: (1) using the Levenstein Distance method to compare string-similarity; (2) using a method for correcting spelling errors in metadata, which is described in greater detail in U.S. patent application Ser. No. 11/831,669 entitled “SYSTEM, APPARATUS AND METHOD FOR DETERMINING CORRECT METADATA FROM COMMUNITY-SUBMITTED DATA”, filed Jul. 31, 2007, the contents of which is hereby incorporated by reference in its entirety. At block 314, the server may store the minimal set of keywords and corresponding interest-categories.

As discussed above, in some embodiments, the database of categories or classes of “interests” may contain indexed specific interests within a category (e.g., music or movies). In such embodiments, a unique-identifier or other form of index may be resulted when the lookup on the database is successful (e.g. “John Mayer” is matched to artist-ID 20360128). Such index or identifier may then be used in the targeted-content description database and can be used to efficiently look up targeted-content or offers appropriate to the matching interest. It is noted that the database of categories or classes of “interests” may have been acquired from third party service providers, or have been constructed within the service server 106 based on previous provided services, etc.

As will be well understood, the additional steps described in connection with block 312 are optional and may not be required for all embodiments of the invention. It is contemplated that such steps may be most relevant in embodiments of the invention in which targeted content is selected based on specific categories or classifications. For example, in the “Music” category, it is expected that a user's tastes will typically be expressed by providing a list of names of artists. In the “Movies” category, a user's tastes will typically be expressed by providing a list of names of movies or actors. As mentioned above, for these categories, a database of artist names or movie names may be acquired from one or more third-parties, or constructed through another data collection mechanism.

In one embodiment, within each interest-category (Music, Movies, Books, Activities, Sports, TV shows), the service server 106 may look-up the corresponding database to find appropriate item(s) or keywords of interest to determine if the user has any potential interests in each interest-category. As will be well appreciated, any suitable matching or searching process may be used to determine the appropriate item(s) or keywords of interest, such as a text string search and match process that look for an exact-character-match, or a search and match process that look for multiple-matches, using a scoring system to pick the closest match (by using a combination of scoring methodologies such as popularity of the matched item or the edit-distance between the user's taste and the potentially matching interest). As previously mentioned, the above discussed steps and stages may be used to eliminate extraneous words (such as “and other similar artists”) in text strings (block 308) that are collected from Web pages where the user used to express a user's tastes and interests, although it is not required and may not be present in all embodiments or implementations.

### Searching and Matching Process

Referring to FIG. 5, a flowchart depicting a matching process is illustrated in accordance with some embodiments. For each keyword (e.g., “Kayaking”, or “John Mayer”, or “Lord of the Rings”), in some embodiment, the service server 106 queries one or more targeted-content databases (potentially relevant to each keyword) to obtain targeted-offers that directly match the keyword. After the query, targeted-offers (e.g., advertisements, promotional materials, offers, etc.) for the user may be resulted. For example, “Used kayaking equipment, Kayaking lessons”, or “John Mayer concert tickets, John Mayer posters”, or “Lord of the Rings on DVD” are resulted after the query using keywords such as “Kayaking”, “John Mayer” and “Lord of the Rings”, respectively. As well appreciated, a targeted-content database may be associated with a particular interest-category. In some embodiments, one or more targeted-content databases may be assembled and provided by a third party based on searches of available materials on web sites, or may be constructed from materials submitted by a third party product and service providers. In some embodiment, the targeted-content database is not associated with a particular interest category but each targeted-offer in the targeted-content database has tag information (or a data field) indicating a relevant interest-category. The categories or discrete items (keywords) relevant to user's interests, preferences, favorites, hobbies, etc. are used to determine content in a database that is specifically targeted to persons having those interests, etc.

Regardless of how the database is constructed, the providers of the product or services may wish to have such materials distributed to social networks. In one embodiment, such providers may be expected to pay a fee for such submissions, bid for placement or priority in distributing such materials, or otherwise pay a fee to make their materials available to users within the service server 106.

In other embodiments, the service server 106 may communicate with a third party service provider to obtain targeted-offers for the user or potentially relevant materials for locating targeted-offers. In one embodiment, the service server 106 may transmit the keywords to one or more third party service providers that offer targeted-content or promotional offers. In another embodiment, the service server 106 may access third-party advertising networks (such as Google™ AdWords or competing advertising networks) that provides marketing promotions/offers and other content across a wide variety of contexts and can automatically match text-strings to relevant offers using their own heuristics and processes. Such third-party advertising networks typically provide an interface for passing in a text string (which in this case would be a user's tastes or category of interest) and returning a list of potentially matching offers or other content. If desired, determination of the potentially relevant materials may be done via a third party offer system, such as Google Adwords/Adsense. Typically, no matter how determined or selected, an offer or other form of materials presented to a user may include a display representation (text, images, HTML), and a link (Web destination) to enable purchase of a product or service, or to learn more about the product or service. For example, for the “Music” category, an offer/content includes, but is not limited to, concert tickets, ring-tones, new-releases, posters, t-shirts, or other merchandise, along with a link to learn more or purchase the item offered. For the “Movies” category, an offer/content may include movie tickets, movie downloads, DVDs, posters, or other merchandise.

The offers or other relevant content may be collected from a database (e.g., a feed of concerts, music new releases, etc.), be submitted by advertisers or providers, or obtained by other suitable method. The offer/content may have a price attached (e.g., the price an advertiser will pay to have the offer displayed, or an affiliate fee associated with transactions if the offer is acted on). If a price is included, the offer-lookup process may choose to pick the offer with the highest price (enabling advertisers to bid, and the system then to select the highest bidder for offers targeted to a particular taste).

### Direct Matching Process

As illustrated at block 502, for each keyword, the service server 106 queries the targeted-content databases to obtain targeted-offers that directly match the keyword. In one embodiment, the service server 106 obtains targeted-offers that match one or more from the set of keywords identified information about the user or the friends of users. In another embodiment, the service server 106 may re-group the set of identified items or keywords into subsets, based on the relevancy to each category. The service server may query a targeted-content database of the relevant interest-category using a subset of items or keywords. For example, for each item or keyword, the service server 106 determines a relevant interest-category. The service server 106 queries a database related to the relevant interest-category, which includes offers (advertisements, promotional materials, offers, etc.) directed to the relevant interest-category. For example, assume that the identified items from the user's information are “Kayaking”, “John Mayer”, and “Lord of the Rings”. For “Kayaking”, the service server 106 determines that the relevant category is “Activities” or “Sports.”

The service server 106 identifies databases of content/offers that are relevant to each category. The service server 106 queries the identified databases of potentially relevant targeted content to determine content (advertisements, promotional materials, offers, etc.) directed to “Activities” or “Sports.” The resulting content may be “Used kayaking equipment” or “Kayaking lessons.” Similarly, for “John Mayer”, a Music category is determined, after a query on relevant databases, the resulting content may be “John Mayer concert tickets” or “John Mayer posters.” This manner, the service server 106 may utilize a different database of offers or content for each vertical category of user tastes (e.g., music, movies) and possibly for each offer or material type (e.g., concerts, ring tones, DVDs) within that category. In addition, the service server 106 can efficiently rule out irrelevant targeted content, even if the targeted content matches keywords or items. For example, since the service server 106 query targeted-content databases related to Music or the category-specific databases, irrelevant results such as “John Mayer offers half price dancing lesson,” may not be resulted after the query with “John Mayer” who is a singer. In this example, looking up the offers or content that matches a user's tastes would typically involve a query like the above, performed against each database within the vertical category of interests.

In some embodiments, the database of offers or content may be collected across all fields of interest and all categories of offers or possible content. In this example, third parties who want to market their offers or materials may be expected to pay to have their offer information added to the database, which then would store such materials indexed by the name (or names) of the interest or category X that the material should be associated with. In such a situation, selecting an appropriate offer or content may be accomplished using a query, such as:

select offers from database, where offer-name includes user-interest-X

OR, to allow an auction-bid advertisement system,

select offers from database,
where offer-name includes user-interest-X,
sort by advertiser's-bided-price

In this case, the collected database of offers or content may include available materials across multiple categories (e.g., music, movies, etc) of potential interests, and multiple categories of content related to those interests.

In another embodiment, the database of content/offers may be provided by a third-party advertising software provider or advertising network. Such systems are typically configured to automatically provide targeted offers or other content given input of a text string. In this case, the text-string used to query a database of content might be a user's discrete text string characterizing a “taste” or “interest”. As mentioned above, third-party advertising networks (such as Google™ AdWords or competing advertising networks) may provide marketing promotions/offers and other content across a wide variety of contexts and can automatically match text-strings to relevant offers using their own heuristics and processes. These systems typically provide an interface for passing in a text string (which in this case would be a user's tastes or category of interest) and returning a list of potentially matching offers or other content.

Note that in the examples above, it is possible that the content-lookup process may result in multiple matches. In this situation, the process may further sort these offers to pick a subset to be displayed to the user, using either price information (choosing the offers which yield the highest advertising revenue when displayed to the user), or using relevancy based on a user characteristic or preference (for example choosing concerts that are closest in time or closest to the user's location).

### Indirect Matching Process

In some embodiments, an indirect matching process may be used in addition to the direct matching process. The indirect matching process may be used to broaden the search for, and selection of content/offers by retrieving content or offers that are designated for categories related to those suggested by the keywords identified from the user's information. At block 504, for each keyword, the service server 106 queries the related keyword databases or performs other methods to obtain additional key words in a second set. This may be accomplished, for example, by the following: for each keyword (e.g., “Kayaking”, or “John Mayer”, or “Lord of the Rings”), query the related keyword database to determine “related” tastes (items or keywords), such as “Wakeboarding, Hiking” (related to Kayaking), “Dave Matthews, Jack Johnson” (related to John Mayer), or “Star Wars” (related to Lord of the Rings). For each related taste, the service server 106 queries the content/offers database to look up potentially matching offers or content as illustrated at block 506. As described, this lookup could be done via a third-party offer system, such as Google Adwords/Adsense. At block 508, the service server 106 stores the targeted-offers for the user and keywords and categories that are used to locate the targeted offers.

In some embodiments, the indirect matching process may be used in a situation where the keywords (representing the user's interests) are to be matched against a category-specific database of tastes and interests (e.g., artist-names, or movie-names, TV show names, book-names, etc.). In addition, a collaborative filtering, recommendation, keyword analysis or other suitable operation may be performed on data characterizing a user's interests, hobbies, tastes, etc. in order to specify relevant items or tastes.

For example, some third party music and movie databases (e.g., from providers such as Muze, AMG, Gracenote, etc.) include related-movies or related-artists data that may be retrieved as part of executing a search query. Further, databases constructed via user-input typically use collaborative filtering techniques (such as cosine-similarity) to “match” taste A to taste B when enough users who contributed to the construction of the database shared both tastes. Such methods of constructing databases is described in greater detail in U.S. patent application Ser. No. 11/511,684 entitled “System, Apparatus And Method For Discovery Of Music Within A Social Network”, filed Aug. 28, 2006, the contents of which is hereby incorporated by reference in its entirety.

It is noted that in some embodiments, the user data collected from the social network could also be used to construct a relevancy matching or related-to type of association based on the expressed interests and preferences of members of the social network and some type of metric for determining a sufficiently close relationship or likelihood of common interest. It is further noted that to calculate offers or other content targeted to a user and his/her network “friends”, the finding relevant items or tastes for the user and also for each friend in the user's list of friends may be performed, followed by either providing the results to the user and friend, or after being subject to further filtering to find the content of highest potential mutual interest for both the user and the friend.

### Targeted Concert Service

In one embodiment, the database of offers or other materials may include a database of concert information (e.g., artist names, concert dates, venues, ticket purchase information, etc.), which can be acquired or integrated from one of many third-party sources. In this embodiment, each keyword relevant or potentially relevant to the user's music interests may be identified. Such keywords may be used to filter matching concerts from the database. As will be understood, other conditions may be used to find matching concerts. For example, a desired location, date and time, venue, etc. can be specified by the user as additional conditions. In one embodiment, if the user does not specify other conditions, default information may be used. For example, a default location for the matching process may be the user's home city or town. This would involve a database query such as:

select concerts from database where concert-name includes X and location=Y, where X is one of the discrete items relevant to the music interest and Y is a desired location.

For example, if X is “John Mayer” and the location is a representation of Seattle, Wash. (e.g., by city name, zip code, or latitude/longitude), the query above would return all concerts including the artist John Mayer, in the specified location. It is noted that in the case of concerts, the location-specific query may either check for an exact-match on location, or a nearness-match within a distance of the specified location. It is further noted that the search for a specific interest such as “John Mayer” may either be a text-based lookup for matching offers, or a database lookup for offers matching an associated identifying string, such as artist-ID 20360128 in the previous example.

The matching concert information may be provided with the user in various formats. For example, in one embodiment, the matching concert information may be sent to the user via email. A further example of a format for delivering the selected content is that of creating a “concert or event calendar” that shows a user a list of all concerts or events that directly match the user's music or other tastes. Such a format might also indicate concerts and events that indirectly match the user's music or other tastes, as well as concerts and events that match a friends' music or other tastes. In addition, based on social network derived data as to the music tastes and/or activities of a user's friends, for each concert or event, the service server 106 may display or otherwise indicate who among a user's friends is most likely to be interested in the concert or event. In one embodiment, one month or a week calendar may be generated including the matching concert information, including, but not limited to, where to buy a ticket, price information, a location (address) where the concert is held, start and end time. Referring to FIG. 6A, an exemplary screen display 600 where a user can view the matching concert information is depicted. As shown, a detailed description 604-608 of each matching concert to a keyword, for example “Jack Smith” is presented. One month calendar 610 including the matching concert information is also presented.

In some embodiments, the offers or content (e.g., matching concert information) may be presented to each user more than once (for example if the offers are to be shown as random advertisements served on various web pages). The targeted-offers for a user may optionally be saved in a database, data-store, or cache for faster retrieval and presentation.

It is noted that the selected content may also be presented to a user based on a time, date, or triggering event. For example, the selected content may be retrieved and cached locally on a user device for later display, with that display determined by the occurrence of a specified user action (a search, web page view, indication of interest, etc.) or date or time, or proximity in date or time to an event of potential interest. In the case of tickets to a concert or event for example, a user may be sent an email alert notifying friends about an upcoming concert or event that directly or indirectly matches their stated interests.

In addition, when presenting an offer or other content, the system can also show who (among a user's “friends”) is most likely to also be interested in the offer or content. For example, if a concert is recommended to a user, the system can show who among the user's “friends” may also like the concert. It is contemplated that, in some embodiments, notice of an event or tickets to a concert could be advertised or offered based on a user or friend's interests or list of favorite artists. Further, based on a sufficient degree of similarity or compatibility between a user and friend, a common advertisement or other information could be presented to both as a way of encouraging activity within the social network. One way of determining a degree of similarity or compatibility between a user and a friend is described in greater detail in U.S. patent application Ser. No. 12/108,431 entitled “SYSTEM, APPARATUS AND METHOD FOR DETERMINING COMPATIBILITY BETWEEN MEMBERS OF A SOCIAL NETWORK”, filed Apr. 23, 2008, the contents of which is hereby incorporated by reference in its entirety.

As discussed above, the various embodiments can be implemented in a wide variety of operating environments, which in some cases can include one or more user computers, computing devices, or processing devices which can be used to operate any of a number of applications. user or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof.

The environment can include a variety of data stores and other memory and storage media as discussed above. These can reside in a variety of locations, such as on a storage medium local to (and/or resident in) one or more of the computers are remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the description as set forth in the claims.

What is claimed is:

1. A method of providing content targeted for a user of a third party social network, comprising:
collecting information about the user from the third party social network;
processing the collected information to identify keywords that are relevant to determining targeted-content for the user;
determining a relevant category for each identified keyword to determine one or more databases;
conducting a search using the each identified keyword over the determined databases for locating matching targeted-content; and
presenting the matching targeted-content to the user.

2. The method of claim 1, wherein collecting information about the user includes collecting information about one or more of the following:
the user's preferences;
the user's favorites;
the user's hobbies; and
the user's interests.

3. The method of claim 2, wherein the information about the user is collected from the user.

4. The method of claim 2, wherein the information about the user is collected from a user profile database.

5. The method of claim 1, wherein processing the collected information includes:
parsing the collected information into a set of discrete keywords;
identifying extraneous keywords that are not to be used for conducting a search; and
obtaining a subset of keywords by removing the extraneous keywords from the set of discrete keywords.

6. The method of claim 1, wherein one or more from the determined databases are provided from an advertising network of a third party.

7. The method of claim 1, wherein conducting a search includes:
performing a direct matching searching; and
performing an indirect matching searching.

8. The method of claim 7, wherein performing a direct matching searching includes, using each identified keyword, querying the determined databases for matching targeted-content.

9. The method of claim 7, wherein performing an indirect matching searching includes:
determining a second keyword, wherein the second keyword is related one or more keywords in the subset determined from the parsed information; and
retrieving targeted-content from the determined databases using the second keyword.

10. The method of claim 1, wherein the targeted-content is one or more of the following:
an advertisement for a product or service;
information regarding a product or service;
an offer to provide a product or service;
a promotion for a good or service; and
a coupon or other incentive for a good or service.

11. The method of claim 1, wherein presenting the matching targeted-content to the user includes:
generating an output including one or more groups of the matching targeted-content; and
presenting the output to the user,
wherein each group is determined based on the keyword and the relevant category for the keyword.

12. The method of claim 1, wherein, if the relevant category is Music, a calendar including the targeted content that is concert information is generated for an output.

13. The method of claim 12, wherein the concert information includes one or more from ticket purchase information, time information, venue information, and singer information.

14. The method of claim 12, wherein the output is sent to the user via an email.

15. The method of claim 1, wherein the matching targeted-content is presented to the user more than once.

16. The method of claim 1, further comprising storing the targeted-content in a user profile database.

17. The method of claim 1, further comprising:
collecting information about friends of the user from the third party social network, wherein the friends are designated by the user in the third party social network;
processing the collected information to identify a second set of keywords that are relevant to determining targeted-content for the user or the friends;
determining a relevant category for each identified keyword in the second set;
conducting a search using the each identified keyword in the second set over the targeted-content databases for locating matching targeted-content; and
presenting the matching targeted-content to the user.

18. The method of claim 17, further comprising, presenting, to the user, information about friends who are interested in the matching targeted-content.

19. The method of claim 11, wherein, if the relevant category is Movies, the output is a calendar including the targeted content that is movie ticket information or other movie related content.

20. The method of claim 1, wherein the matching targeted-content is presented to the user in a Web page or via email.

21. The method of claim 1, wherein the matching targeted-content is provided by a third party service provider.

22. A system for providing content targeted for a user of a third party social network, the system comprising:
a processor; and
a memory device including instructions that, when executed by the processor, cause the processor to:
collect information about the user from the third party social network;
process the collected information to identify keywords that are relevant to determining targeted-content for the user;
determine a relevant category for each identified keyword;
conduct a search using the each identified keyword over content databases for locating targeted-content that matches the identified keyword; and
present the matching targeted-content to the user.

23. The system of claim 22, wherein the information about the user includes one or more of the following:
the user's preferences;
the user's favorites;
the user's hobbies; and
the user's interests.

24. The system of claim 22, wherein one or more of the content databases are constructed and maintained by a third party service provider that provides the system with a network interface to access the one or more of the content databases.

25. The system of claim 22, wherein the memory device further includes instructions that, when executed by the processor, cause the processor to:
parse the collected information into a set of discrete keywords;
identify extraneous keywords that are not to be used for conducting a search; and
obtain a subset of keywords by removing the extraneous keywords from the set of discrete keywords.

26. The system of claim 25, wherein the memory device further includes instructions that, when executed by the processor, cause the processor to perform a direct matching searching using each identified keyword, querying the content databases for matching targeted-content.

27. The system of claim 26, wherein the memory device further includes instructions that, when executed by the processor, cause the processor to:
determine a second keyword, wherein the second keyword is related one or more keywords in the subset determined from the parsed information; and
retrieve targeted-content from the databases using the second keyword.

28. The system of claim 22, wherein the targeted-content is one or more of the following:
an advertisement for a product or service;
information regarding a product or service;
an offer to provide a product or service;
a promotion for a good or service; and
a coupon or other incentive for a good or service.

29. The system of claim 22, wherein the memory device further includes instructions that, when executed by the processor, cause the processor to:
group the matching targeted-content based on corresponding category;
generate an output based the grouping result; and
present the output to the user.

30. The system of claim 22, wherein, if the relevant category is Music, the output is a calendar including the targeted content that is concert information.

31. The system of claim 30, wherein the concert information includes one or more from ticket purchase information, time information, venue information, and singer information.

32. The system of claim 22, wherein the memory device further includes instructions that, when executed by the processor, cause the processor to:
collect information about friends of the user from the third party social network, wherein the friends are designated by the user in the third party social network;
process the collected information to identify a second set of keywords that are relevant to determining targeted-content for the user or the friends;
determine a relevant category for each identified keyword in the second set;
conduct a search, using the each identified keyword in the second set and the relevant category, over the targeted-content databases for locating matching targeted-content; and
presenting the matching targeted-content to the user.

33. A method of providing concert content targeted for a user of a social network, comprising:
collecting information about the user from the social network;
processing the collected information to identify keywords that are relevant to determining concert content targeted for the user;
conducting a search using the each identified keyword over databases for locating matching concert content;
generating an output including the matching concert content; and
presenting the output to the user.

34. The method of claim 33, wherein the output is a calendar including information about the matching concert content.

35. The method of claim 33, wherein the information about the matching concert content includes one or more of ticket purchase information, time information, venue information, or artist information.

36. The method of claim 33, further comprising enabling a user to purchase a ticket for the matching concert content.

37. The method of claim 33, further comprising enabling a user to inform a friend in the social network about the matching concert content.

38. The method of claim 33, wherein the output is sent to the user via an email.

39. The method of claim 33, wherein the information about the user includes one or more information about preferences, interests, hobbies, and likes of the user.

40. The method of claim 33, wherein the information about the user includes information about friends of the user, including one or more information about preferences, interests, hobbies, and likes of each friend.

41. The method of claim 40, wherein information about a friend who is interested in the matching concert content is present to the user.

42. The method of claim 41, wherein the friend who is interest in the matching concert content is identified based on the one or more information about preferences, interests, hobbies, and likes of the friend.

43. The method of claim 42, wherein the identified friend receives the formation about the matching concert content.

44. The method of claim 33, further comprising enabling the user to specify criteria for the search.

45. The method of claim 44, wherein the specified criteria include a desired location of a concert.

46. The method of claim 33, wherein additional information is collected and processed for locating more matching concert content.

47. The method of claim 46, wherein the additional information is collected from a third party social network where the user is a member.

48. The method of claim 33, further comprising:
if the social network is a third party:
obtaining, from the user, a permission to access the social network, and
accessing the social network using the permission to obtain information relating to determining targeted-concert content,
wherein the obtained information includes information about the user and a list of friends designated by the user within the social network.

49. The method of claim 48, wherein accessing the third party social network includes using an API interface to directly access the third party social network.

50. The method of claim 49, wherein the API interface is provided by the third party social network.

51. The method of claim 48, wherein accessing the third party social network includes using screen scraping to obtain the list of friends.

52. The method of claim 51, wherein the permission is a user's login credential information.

53. The method of claim 51, wherein the information about the friend is obtained through screen scraping of a Web page in the third party social network.

54. A server for providing concert content targeted for a user of a social network, the server comprising:
one or more databases for storing information about the user, concert content items, related-keywords, and interest-categories; and
a computing device communicatively coupled to the database, the computing device is operable to:
obtain information about the user;
process the obtained information to identify keywords that are relevant to determining concert content targeted for the user;
conduct a search using the each identified keyword over the databases for locating matching concert content items;
generate an output including the matching concert content items in a predetermined format; and
present the output to the user.

55. The server of claim 54, wherein the predetermined format is a calendar format, a Web page format, an email format, or text message format.

56. The server of claim 54, wherein the server communicates with a third party service provider to obtain the matching concert content items, the third party service provider independently managing concert content items.

57. A method for finding targeted-content for a user with a first set of keywords that are identified from information about the user, the method comprising:
conducting a search over targeted-content databases with each keyword in the first set;
obtaining search results including targeted content that matched at least one keyword in the first set;
obtaining a second set of keywords by querying a related keyword database using each keyword in the first set,
wherein a keyword in the second set is relevant to at least one keyword in the first set;
conducting a search over the targeted-content databases with each keyword in the second set; and
obtaining additional search results including targeted content that matched at least one keyword in the second set.

58. The method of claim 57, wherein the obtained search results are presented to the user as direct matching content.

59. The method of claim 57, wherein the obtained additional search results are presented to the user as indirect matching content.

60. The method of claim 57, wherein the targeted content includes an advertisement, an offer, a promotion material, information about a product, information about a service, or a discount coupon.
